(19) United States
(12) Patent Application Publication
(10) Pub. No.: US 2022/0231909 A1
(43) Pub. Date: Jul. 21, 2022

(54) PLUG-IN GENERATION DEVICE, CONTROLLER, PLUG-IN GENERATION METHOD, AND PLUG-IN GENERATION PROGRAM

(71) Applicant: Nippon Telegraph and Telephone Corporation, Tokyo (JP)

(72) Inventors: Masatoshi Saito, Musashino-shi, Tokyo (JP); Aki Fukuda, Musashino-shi, Tokyo (JP); Yoshinori Koike, Musashino-shi, Tokyo (JP)

(21) Appl. No.: 17/615,406

(22) PCT Filed: Jun. 21, 2019
(86) PCT No.: PCT/JP2019/024625

§ 371 Date: Nov. 30, 2021

(51) Int. Cl. H04L 41/0806

(52) U.S. Cl. CPC H04L 41/0806

(57) ABSTRACT

A plugin generation device (10) includes: a mapping loading unit (11) that loads, into a controller (20) that transmits instruction information with respect to a network device from a service model (21) that receives the instruction information to a device model (23) that notifies the network device of the received instruction information, first mapping information between the service model (21) and a common model (22) and second mapping information between the common model (22) and the device model (23) as information for mapping the service model (21) and the device model (23), respectively; a config loading unit (12) that loads preconditions for generating a plugin as config information; and a plugin generation unit (13) that generates a plugin to be incorporated into the controller (20) on the basis of the first mapping information, the second mapping information, and the config information.

### TECHNICAL FIELD

The present invention relates to a plugin generation device, a controller, a plugin generation method, and a plugin generation program.

### BACKGROUND ART

Software-defined networking (SDN) is a concept that enables flexible virtualization of networks. This allows a service provider to procure adequate network resources as needed from a network provider. An SDN controller is a device that receives an instruction from a service provider application, and controls a physical network device of the network provider.

A northbound interface (NBI) in the SDN controller is a service model responsible for the interface with the application.

A southbound interface (SBI) in the SDN controller is a device model responsible for the interface with the network device.

With this arrangement, the application transmits a control command for a network device to the service model, and the network device receives the control command from the device model. The control command is an operation for inputting a config (network device settings information), for example. Patent Literature 1 describes how a config with existing settings is migrated to another device.

As a development environment (framework) for such an SDN controller, model-driven frameworks like the following exist.
“OpenDaylight” described in Non-Patent Literature 1
“Open Networking Operating System (ONOS)” described in Non-Patent Literature 2
“Network Services Orchestrator (NSO)” described in Non-Patent Literature 3

These frameworks make development easier by accepting a data model defined in a data model language such as YANG as input, and outputting a portion (a service, a datastore) of the SDN controller.

### CITATION LIST

### Patent Literature

Patent Literature 1: Japanese Patent Laid-Open No. 2018-136649

### Non-Patent Literature

Non-Patent Literature 1: LF Projects, LLC, “OpenDaylight”, [online], [retrieved Jun. 13, 2019], Internet <URL: https://www.opendaylight.org/>

Non-Patent Literature 2: The ONOS Project, “ONOS is building a better network”, [online], [retrieved Jun. 13, 2019], Internet <URL: https://onosproject.org/>

Non-Patent Literature 3: Cisco Systems, Inc., “Cisco Network Services Orchestrator 4.7”, [online], Jun. 14, 2018 [retrieved Jun. 13, 2019], Internet <URL: https://www.cisco.com/c/ja_jp/support/cloud-systems-management/network-services-orchestrator-4-7/model.html>

### SUMMARY OF THE INVENTION

### Technical Problem

In the frameworks of the related art described above, the service framework in the SDN controller is generated automatically, but a developer needs to develop the internal processing logic separately as a plugin. The processing logic written in a plugin defines a mapping between the service model and the device model, such as from which service model to which device model the config is input. This mapping between models is an important step in the process of developing an SDN app. Note that some operations of inputting a config do not include complex logic such as setting a loopback address, while others include complex logic for traffic engineering (TE) such as granting an exclusive band and a delay budget to a specific flow as a policy, for example.

FIG. 19 is a simplified diagram of mappings between models. For example, from three service models (NBI A, B, and C) and three device models (SBI A, B, and C), a first mapping from “NBI A” to “SBI A” and a second mapping from “NBI B” to “SBI C” are created. FIG. 20 is a configuration diagram of an SDN controller that embodies the mappings between models in FIG. 19. A plugin A of a service A embodying “NBI A” relays instructions from a datastore A to the device model “SBI A” as the first mapping.

A plugin B of a service B embodying “NBI B” and a plugin C of a service C embodying “NBI C” relay instructions from a datastore C to the device model “SBI C” as the second mapping.

FIG. 21 is a diagram illustrating the problem of the number of mappings between models. The number of mappings between models is the number of combinations of a service model and a device model. For example, in a controller model 200, if five service models “A” to “E” in a service definition 201 and four device models “1” to “4” in a device definition 203 are combined, the number of mappings is 5×4=20 (the number of arrows indicated by the sign 202).

Consequently, the developer needs to prepare 20 mapping definition files individually, and even if the processing logic of each one is simple, the increase in the number of mappings itself is a heavy burden. Particularly, in the case of constructing a multi-vendor system, the device models of a variety of vendors need to be handled individually, and the number of mappings also increases.

Note that although the framework of the related art assists with the generation of service models and device models, assistance for reducing the burden of the mappings between models is not provided. For this reason, the developer feels a heavy burden in the step of developing the mappings between models.

Accordingly, a major issue addressed by the present invention is reducing the burden of developing mappings between services and devices when a plurality of services control a plurality of network devices.

### Means for Solving the Problem

To address the issue, a plugin generation device of the present invention has the following features. The present invention includes: a mapping loading unit that loads, into a controller that transmits instruction information with respect to a network device from a service model that receives the instruction information to a device model that notifies the network device of the received instruction information, first mapping information between the service model and a common model and second mapping information between the common model and the device model as information for mapping the service model and the device model, respectively;

a config loading unit that loads preconditions for generating a plugin as config information;

a plugin generation unit that generates a plugin to be incorporated into the controller on the basis of the first mapping information, the second mapping information, and the config information; and

a plugin output unit that outputs the created plugin to the controller, and thereby causes the controller to execute a process of transmitting the instruction information according to the first mapping information and the second mapping information.

### Effects of the Invention

According to the present invention, it is possible to reduce the burden of developing mappings between services and devices when a plurality of services control a plurality of network devices.

### BRIEF DESCRIPTION OF DRAWINGS

FIG. 1 is a configuration diagram of a plugin generation device according to the present embodiment.

FIG. 2 is a hardware configuration diagram of the plugin generation device according to the present embodiment.

FIG. 3 is a configuration diagram of a controller model according to the present embodiment.

FIG. 4 is a configuration diagram illustrating an example of the controller model in FIG. 3 according to the present embodiment.

FIG. 5 is a diagram illustrating a mapping definition file in YANG notation for a single service model according to the present embodiment.

FIG. 6 is a diagram illustrating the mapping definition file of FIG. 5 in tree notation according to the present embodiment.

FIG. 7 is a diagram illustrating a mapping definition file in YANG notation for a single common model according to the present embodiment.

FIG. 8 is a diagram illustrating the mapping definition file of FIG. 7 in tree notation according to the present embodiment.

FIG. 9 is a diagram illustrating a mapping definition file in YANG notation for a single device model according to the present embodiment.

FIG. 10 is a diagram illustrating the mapping definition file of FIG. 9 in tree notation according to the present embodiment.

FIG. 11 is a diagram illustrating a mapping definition file of first mapping information in tree notation according to the present embodiment.

FIG. 12 is a diagram illustrating a mapping definition file of second mapping information in tree notation according to the present embodiment.

FIG. 13 is a configuration diagram illustrating a controller as a class model according to the present embodiment.

FIG. 14 is a sequence diagram illustrating a process by the plugin generation device according to the present embodiment.

FIG. 15 is a configuration diagram illustrating an object model of the controller according to the present embodiment.

FIG. 16 is a sequence diagram mainly illustrating a process by a service A management unit according to the present embodiment.

FIG. 17 is a sequence diagram mainly illustrating a process by a common model management unit according to the present embodiment.

FIG. 18 is a sequence diagram mainly illustrating a process by a device C management unit according to the present embodiment.

FIG. 19 is a simplified diagram of mappings between models.

FIG. 20 is a configuration diagram of an SDN controller that embodies the mappings between models in FIG. 19.

FIG. 21 is a diagram illustrating the problem of the number of mappings between models.

### DESCRIPTION OF EMBODIMENTS

Hereinafter, an embodiment of the present invention will be described in detail and with reference to the drawings.

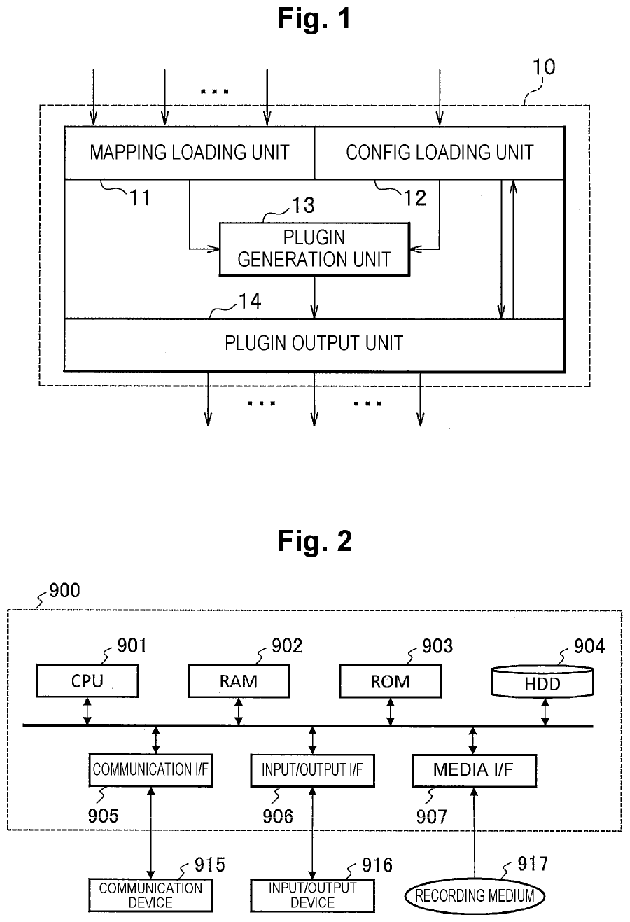

FIG. 1 is a configuration diagram of a plugin generation device 10.

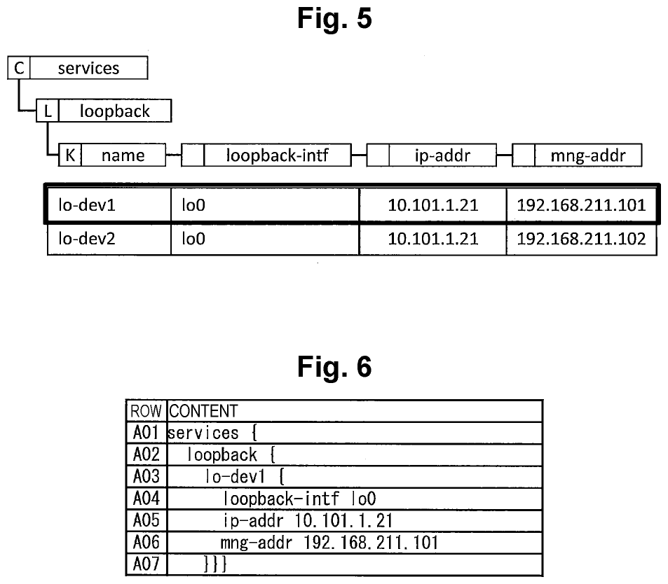

The plugin generation device 10 includes a mapping loading unit 11, a config loading unit 12, a plugin generation unit 13, and a plugin output unit 14. The mapping loading unit 11 loads a mapping definition file containing information about mappings between models (for details, see FIGS. 5 to 12), and transmits the loaded mapping information to the plugin generation unit 13.

The config loading unit 12 loads config information indicating common preconditions for generating a plugin from a config file, and transmits the loaded config information to the plugin generation unit 13. In the config information, the following information is stated as the preconditions, for example.
The class of plugin to generate (a service model—common model plugin, or a device model—device model plugin)
A common model used by the plugin to generate
The format of the file in which the plugin is output (such as a Java(R) file or a py file)
A process when outputting the plugin (for example, a process of installing or updating a feature based on the Open Service Gateway Initiative (OSGi) architecture) The plugin generation unit 13 accepts mapping information and config information as input, and generates a plugin. The plugin is a program that executes a mapping between models on the basis of the mapping information.

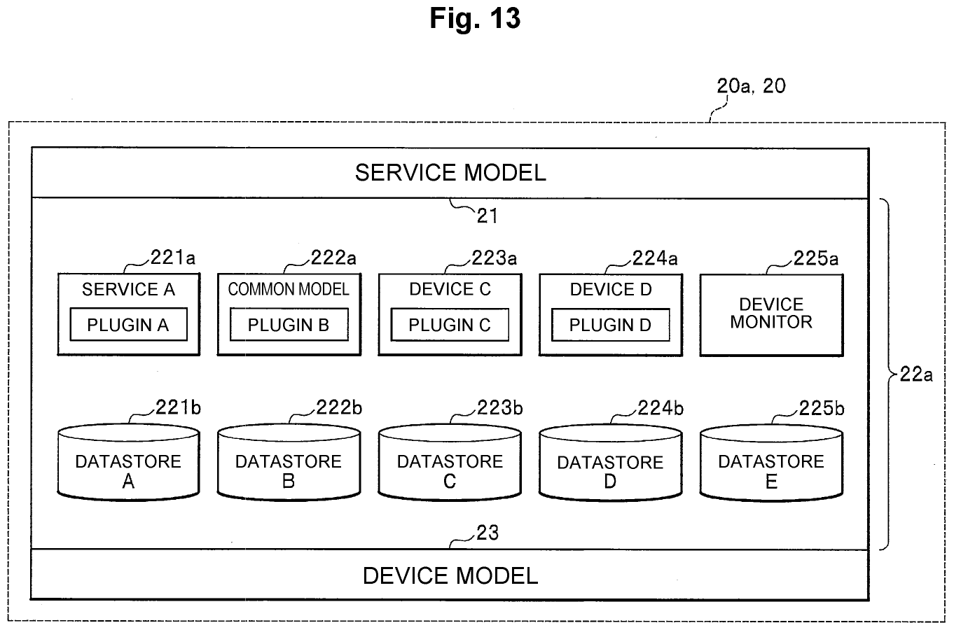

The plugin output unit 14 converts the generated plugin to a format specified by the config, and outputs to a controller 20 (FIG. 13). On the other hand, in the case where the plugin is not generated successfully, null is returned to the controller 20.

FIG. 2 is a hardware configuration diagram of the plugin generation device 10.

The plugin generation device 10 is configured as a computer 900 including a CPU 901, RAM 902, ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data with respect to a recording medium 917. Furthermore, the CPU 901 controls each processing unit by executing a program (also referred to as an application, which may be abbreviated to app) loaded into the RAM 902. Additionally, the program may also be distributed through a communication channel or by being recorded onto a recording medium 917 such as CD-ROM.

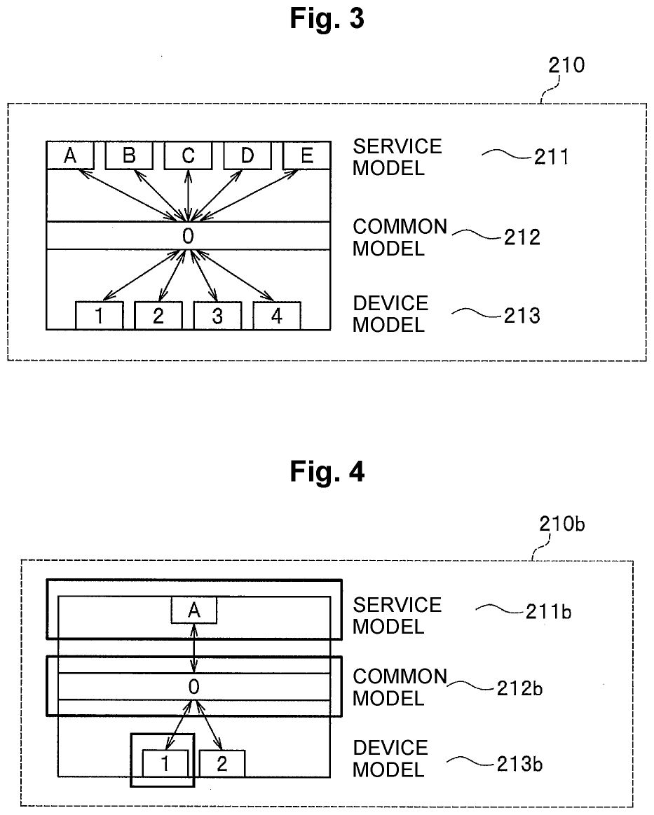

FIG. 3 is a configuration diagram of a controller model 210.

The controller model 210 is an abstract data representation modeling the controller 20 (FIG. 13) as an SDN controller. In the controller model 210, service models 211, a common model 212, and device models 213 are mapped.

Here, the “common model 212” is newly introduced between the service models 211 and the device models 213 in the controller 20 as a mechanism that reduces the burden of mapping between models while also utilizing the framework of a model-driven SDN controller.

In other words, a model-driven SDN controller has a one-stage mapping in which the service models 211 and the device models 213 are mapped directly. On the other hand, in the present embodiment, the mapping is expanded into a two-layer mapping including a first-stage mapping between the service models 211 and the common model 212, and a second-stage mapping between the common model 212 and the device models 213.

In this way, the service models 211 are mapped to the common model 212 without being mapped directly to the device models 213. Because the service provider does not have to create mappings to the device models 213 not under direct management by the service provider itself, the burden of creating mapping definition files is reduced.

Similarly, the device models 213 are mapped to the common model 212 without being mapped directly to the service models 211. Because the network provider does not have to create mappings to the service models 211 not under direct management by the network provider itself, the burden of creating mapping definition files is reduced. With this arrangement, if five service models 211 and four device models 213 are combined, the number of mappings is only 5+4=9, a reduction from the 20 mappings in FIG. 21.

FIG. 4 is a configuration diagram illustrating an example of the controller model 210 in FIG. 3. In a controller model 210b obtained by extracting a portion of the controller model 210 in FIG. 3, a service model 211b, a common model 212b, and a device model 213b are mapped. Hereinafter, FIGS. 5 to 12 will be referenced to give an example of a specific mapping definition file of each model in the controller model 210b. These mapping definition files are input as input data into the plugin generation device 10 by a provider or the like.

FIG. 5 is a diagram illustrating a mapping definition file in YANG notation for a single service model.

FIG. 6 is a diagram illustrating the mapping definition file of FIG. 5 in tree notation. The mapping definition file contains an assignment of an interface name “1o0” and an address “10.101.1.21/32” as a loopback interface. For example, “1o-dev1” outlined in bold in the element “name” in FIG. 5 corresponds to the row A03 in FIG. 6. Also, a key for specifying the device to be mapped is stated as the element “mng-addr” in FIG. 5 and the row A06 in FIG. 6.

On the other hand, although omitted from illustration, a mapping file including the four basic arithmetic operations may also be used, such as by defining a parameter “dev-id” of the service model and setting the loopback setting parameter (ip-addr) to “1.1. (dev-id+100).1”.

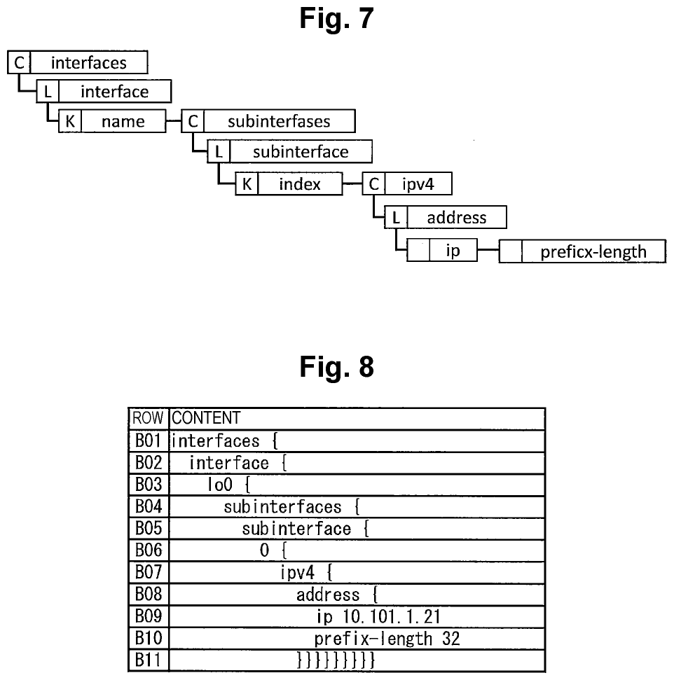

FIG. 7 is a diagram illustrating a mapping definition file in YANG notation for a single common model.

FIG. 8 is a diagram illustrating the mapping definition file of FIG. 7 in tree notation. The tree notation is an extraction of only the loopback setting portion, and in actuality, other setting portions are also included. For example, the element “name” in FIG. 7 corresponds to the row B03 in FIG. 8. Also, the element “index” in FIG. 7 corresponds to the row B06 in FIG. 8.

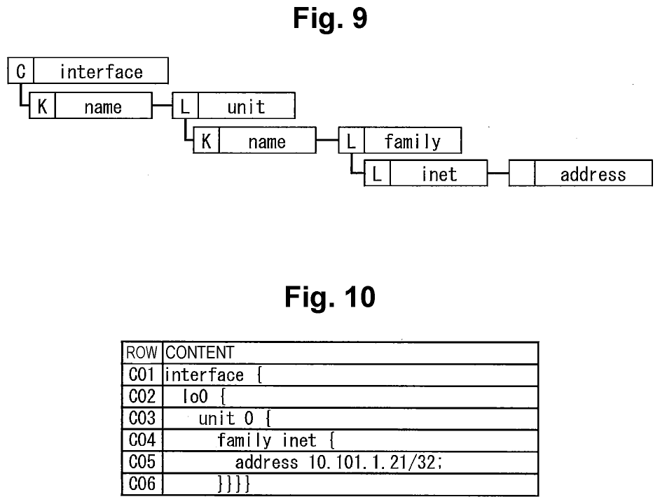

FIG. 9 is a diagram illustrating a mapping definition file in YANG notation for a single device model.

FIG. 10 is a diagram illustrating the mapping definition file of FIG. 9 in tree notation. The tree notation is an extraction of only the loopback setting portion, and in actuality, other setting portions are also included. For example, the element “name” in FIG. 9 corresponds to the row CO2 in FIG. 10.

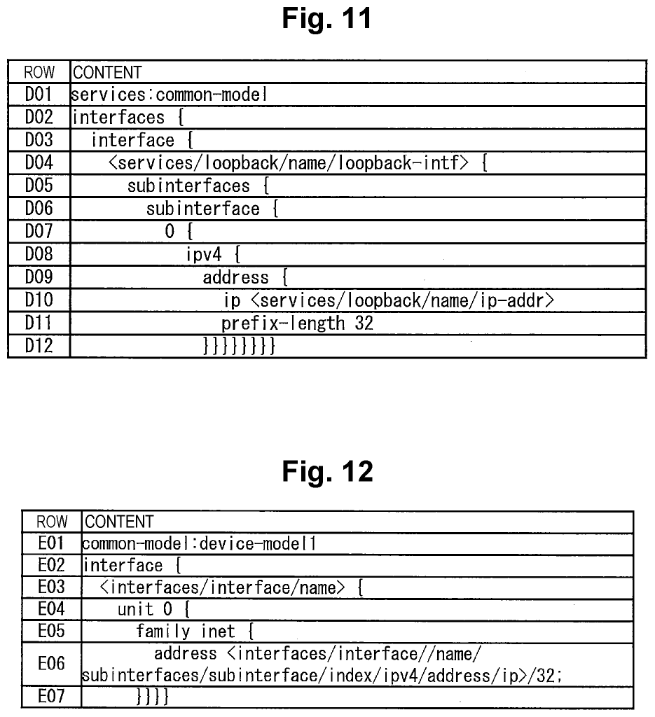

FIG. 11 is a diagram illustrating a mapping definition file of first mapping information in tree notation.

This mapping definition file is obtained by applying the parameters in the mapping definition file for a single service model in FIG. 6 to the mapping definition file for a single common model in FIG. 8. In other words, by applying parameters in a higher layer to messages in a lower layer, a provider creates first mapping information to be treated as input data for the plugin generation device 10.

The contents of the row D04 and the row D10 are changed after application. Note that the row DO1 indicates that the mapping definition file is between a service model 211 and the common model 212.

FIG. 12 is a diagram illustrating a mapping definition file of second mapping information in tree notation.

This mapping definition file is obtained by applying the parameters in the mapping definition file for a single common model in FIG. 8 to the mapping definition file for a single device model in FIG. 10. Like FIG. 11, by applying parameters in a higher layer to messages in a lower layer, a provider creates second mapping information to be treated as input data for the plugin generation device 10.

The contents of the row E03 and the row E06 are changed after application. Note that the row E01 indicates that the mapping definition file is between the common model 212 and a device model 213.

FIG. 13 is a configuration diagram illustrating the controller 20 as a class model 20a.

The controller 20 includes a service model 21, a common model 22a, and a device model 23.

Like FIG. 20, the common model 22a includes services (a service A 221a, a common model 222a, a device C 223a, a device D 224a, and a device monitor 225a) and a datastore corresponding to each service (a datastore A 221b, a datastore B 222b, a datastore C 223b, a datastore D 224b, and a datastore E 225b).

Each service of the class model 20a achieves the following functions by incorporating respective plugins A to D generated by the plugin generation device 10.
The service A 221a incorporates the plugin A, and thereby provides access to an application through the service model 21, and transmits information to the common model 222a.
The common model 222a incorporates the plugin B, and thereby specifies the machine (device) that is the target of the information transmitted from the service A 221a, and transmits information to the specified device (the device C 223a or the device D 224a).
The device C 223a incorporates the plugin C, and thereby provides access to a physical network device through the device model 23 in accordance with the information transmitted from the common model 222a.
The device D 224a likewise incorporates the plugin D, and thereby provides functions similar to the device C 223a with respect to a different network device. Furthermore, the device monitor 225a provided as the framework of the model-driven SDN controller stores information about the mounted network devices. This arrangement makes it possible to search for a target machine with respect to the common model 222a.

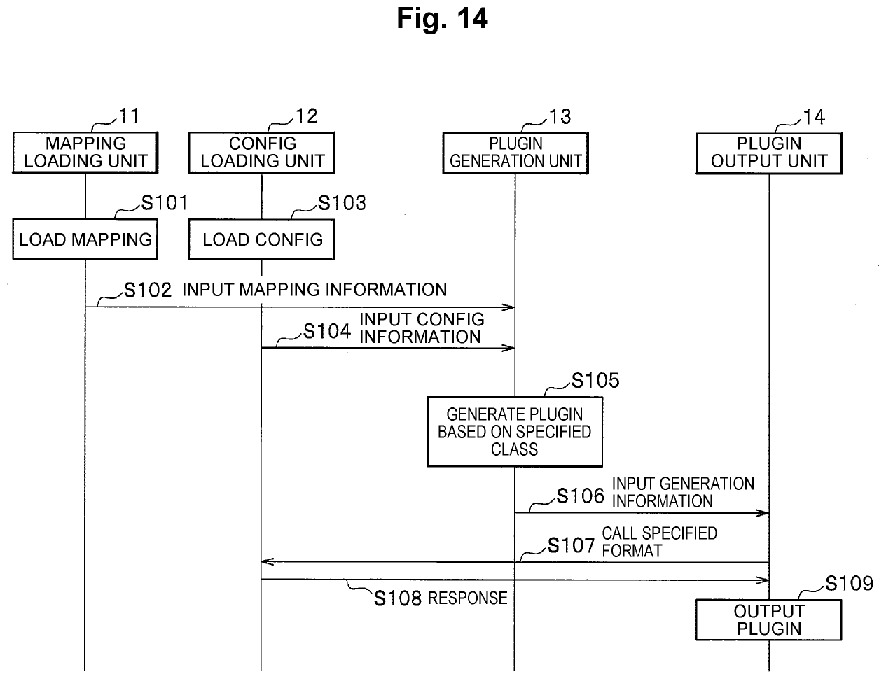

FIG. 14 is a sequence diagram illustrating a process by the plugin generation device 10. The mapping loading unit 11 loads the mapping definition file (with parameters applied) illustrated in FIGS. 11 and 12 (S101), and inputs the mapping information into the plugin generation unit 13 (S102).

The config loading unit 12 loads a config file (S103), and inputs the config information into the plugin generation unit 13 (S102).

The plugin generation unit 13 generates a plugin for executing the mapping information on the basis of the class specified by the config information (S105), and inputs information about the generated plugin into the plugin output unit 14 (S106). Here, the plugin generation unit 13 generates a plugin of a different class according to the content of the mapping in the scope of predetermined logic.

The plugin output unit 14 calls the specified format of the config information with respect to the config loading unit 12 (S107), and obtains a response (S108). The plugin output unit 14 converts the plugin input in S106 to the specified format of the config information, and then outputs to the controller 20.

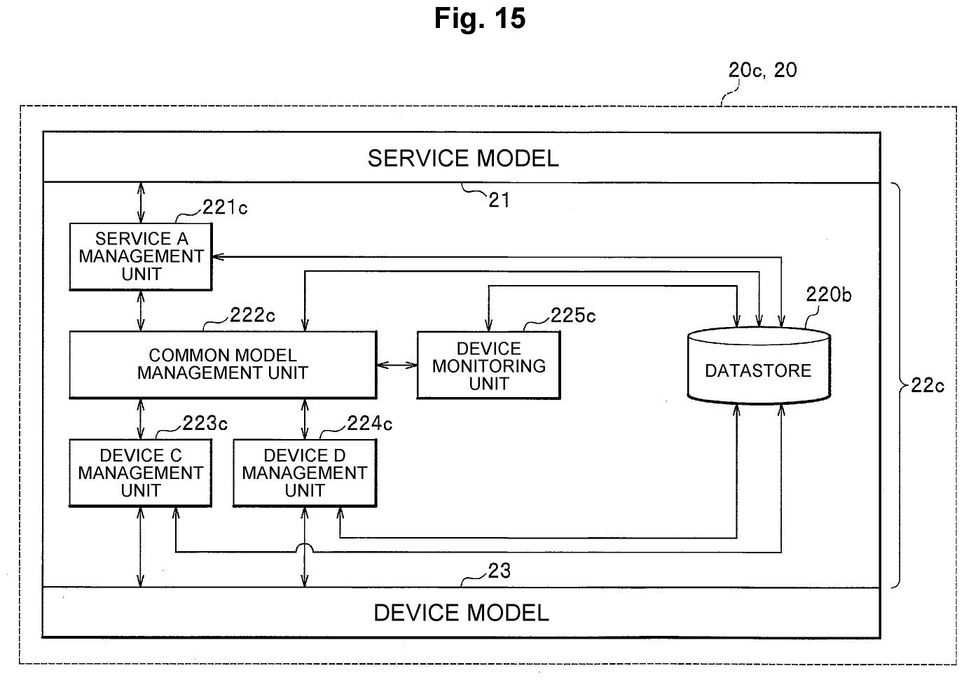

FIG. 15 is a configuration diagram illustrating an object model 20c of the controller 20. In the object model 20c, the plugins input by the plugin output unit 14 are incorporated into the class model 20a of FIG. 13. A service A management unit 221c is obtained by incorporating the first mapping information (FIG. 11) between the service A 221a and the common model 222a as the plugin A.

A common model management unit 222c is obtained by incorporating the second mapping information (FIG. 12) between the common model 222a and a target device (the device C 223a or the device D 224a) as the plugin B.

A device C management unit 223c is obtained by incorporating the second mapping information between the common model 222a and a target device (the device C 223a) as the plugin C.

A device D management unit 224c is obtained by incorporating the second mapping information between the common model 222a and a target device (the device D 224a) as the plugin D.

The device C management unit 223c and the device D management unit 224c executes a management command such as a NETCONF command on the device model 23, and determines whether the config input is successful or not from the notification result.

A device monitoring unit 225c is an execution object of the device monitor 225a. Also, a datastore 220b is a collective term for the datastore A 221b, the datastore B 222b, the datastore C 223b, the datastore D 224b, and the datastore E 225b in FIG. 13.

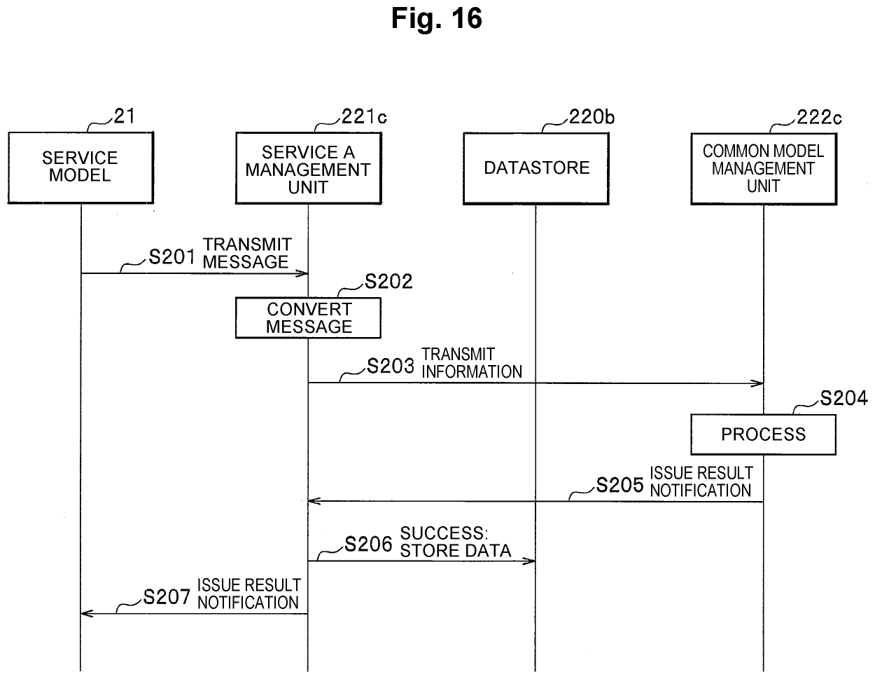

Hereinafter, FIGS. 16 to 18 will be referenced to describe operations by the controller 20 in detail. FIG. 16 is a sequence diagram mainly illustrating a process by the service A management unit 221c.

The service model 21 transmits a message received from an application to the service A management unit 221c (S201). Note that the content of the message conforms to the data model.

The service A management unit 221c converts the content of the received message to be compatible with the common model management unit 222c (S202), and transmits information about the conversion result to the common model management unit 222c (S203).

Note that the transmitted content in S203 may be “Create” indicating object generation, “Update” indicating object modification, and “Delete” indicating object removal, for example. In these cases, information about the target equipment (such as an address and an equipment ID) treated as the transmission destination is included in the transmitted content.

Alternatively, the transmitted content may be “Get” indicating the acquisition of information in some cases. In this case, it is sufficient to query the datastore 220b managed by the service A management unit 221c, and return the information obtained by the response (not illustrated).

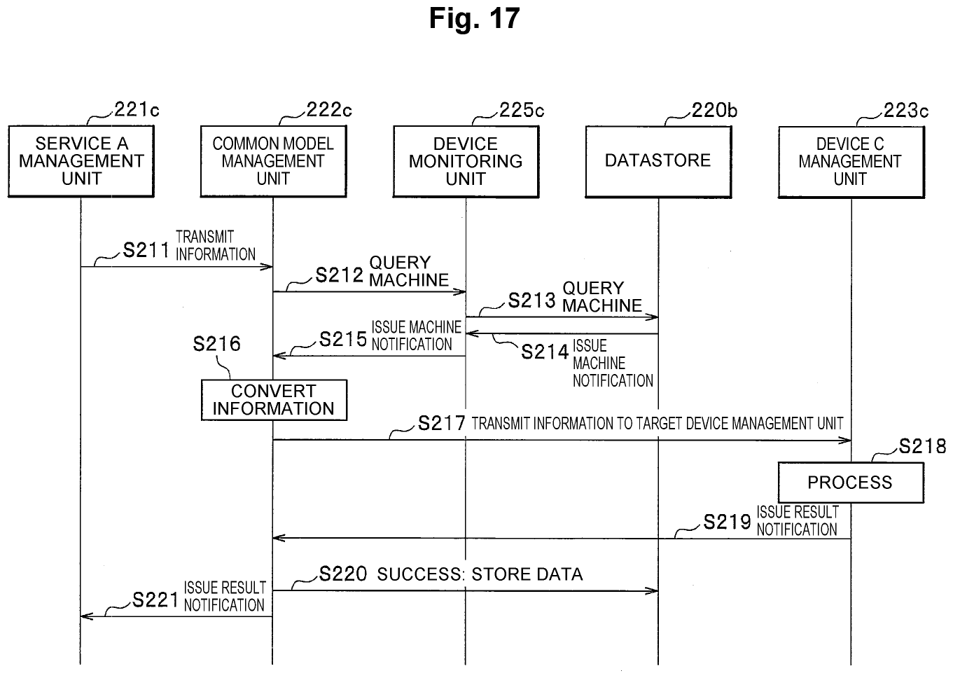

The common model management unit 222c processes the transmitted information (S204, details in FIG. 17), and notifies the service A management unit 221c of the result (S205). The service A management unit 221c stores the notification result of S205 (for example, a successful process) in the datastore 220b (S206), and also notifies the service model 21 of the notification result of S205 (S207).

FIG. 17 is a sequence diagram mainly illustrating a process by the common model management unit 222c.

The common model management unit 222c receives the information transmission from the service A management unit 221c (S211, or S203 in FIG. 16), and queries the device monitoring unit 225c for the machine of the target equipment (S212).

The device monitoring unit 225c receives the query of S212, and by searching the datastore 220b according to the machine query (S213), causes a notification of the machine of the target equipment to be issued (S214). Consequently, in the datastore 220b, an equipment management table associating an equipment ID, a management address, and a machine (model name) for each mounted (registered) network device is prepared in advance.

The common model management unit 222c receives the notification of the machine of the target equipment from the device monitoring unit 225c (S215), and converts the information into information specifying the target equipment (network device) (S216). Hereinafter, the description will continue by treating the device C 223a as the target equipment. Also, in S216, the common model management unit 222c may also converts the instruction content (parameters) transmitted in S211 on the basis of a mapping definition file.

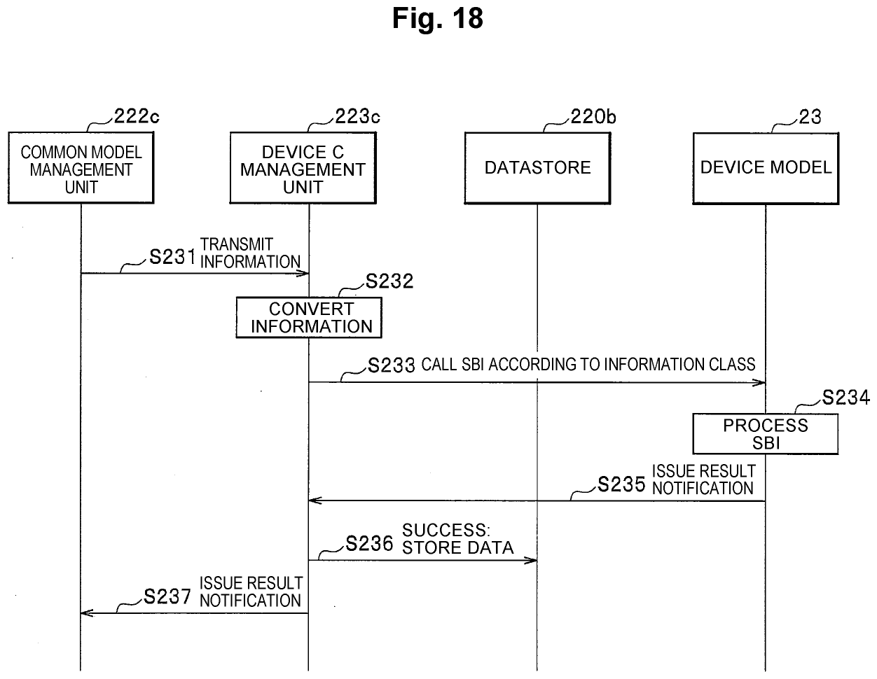

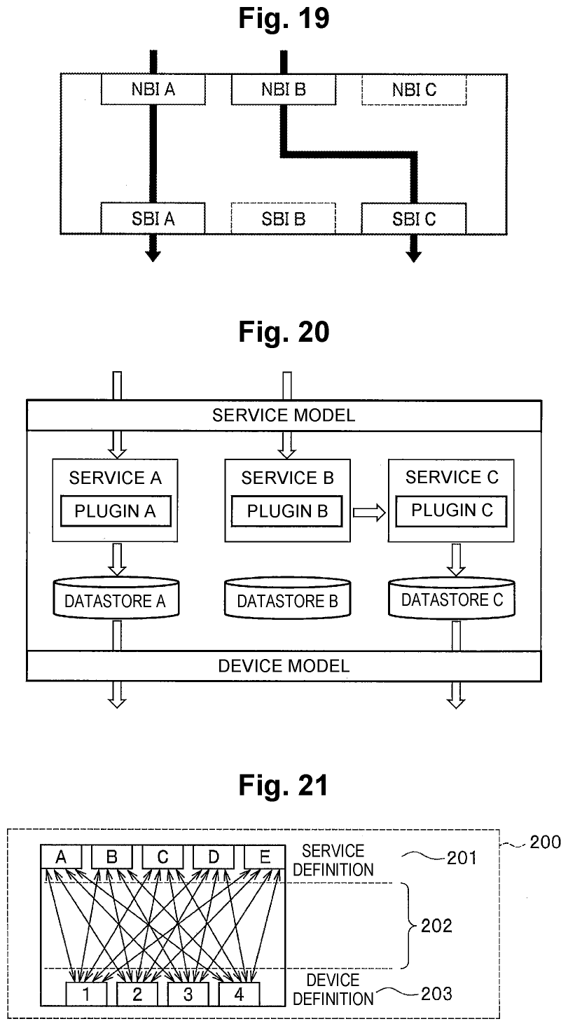

The common model management unit 222c transmits the instruction (such as Create, Update, or Delete) transmitted from the service A management unit 221c in S211 to the device C management unit 223c of the target equipment obtained in S216 (S217), and causes the device C management unit 223c to process the instruction (S218, details in FIG. 18).

The device C management unit 223c notifies the common model management unit 222c of the result of S218 (S219). The common model management unit 222c stores the notification result of S219 (for example, a successful process) in the datastore 220b (S220), and also notifies the service A management unit 221c of the notification result of S219 (S221).

FIG. 18 is a sequence diagram mainly illustrating a process by the device C management unit 223c.

The device C management unit 223c receives the information transmission from the common model management unit 222c (S231, or S217 in FIG. 17), and converts the information to be compatible with the device model 23 (S232).

The device C management unit 223c calls the SBI according to the information class by transmitting information about the conversion result in S232 to the device model 23 (S233).

The device model 23 receives the call in S233, and causes the instruction transmitted in S231 (such as Create, Update, or Delete) to be processed by the network device managed by the device C management unit 223c (S234).

The device C management unit 223c receives a notification of the result of S234 from the device model 23 (S235). Additionally, the device C management unit 223c stores the result notification of S235 (for example, a successful process) in the datastore 220b (S236), and also notifies the common model management unit 222c of the result notification of S235 (S237). On the other hand, in the case where the result notification of S235 indicates failure, the process of storing in the datastore 220b (S236) is omitted.

### Advantageous Effects

A plugin generation device 10 of the present invention includes: a mapping loading unit 11 that loads, into a controller 20 that transmits instruction information with respect to a network device from a service model 21 that receives the instruction information to a device model 23 that notifies the network device of the received instruction information, first mapping information between the service model 21 and a common model 22 and second mapping information between the common model 22 and the device model 23 as information for mapping the service model 21 and the device model 23, respectively;

a config loading unit 12 that loads preconditions for generating a plugin as config information;

a plugin generation unit 13 that generates a plugin to be incorporated into the controller 20 on the basis of the first mapping information, the second mapping information, and the config information; and

a plugin output unit 14 that outputs the created plugin to the controller 20, and thereby causes the controller 20 to execute a process of transmitting the instruction information according to the first mapping information and the second mapping information.

With this arrangement, through the introduction of an architecture newly provided with the common model 22 as an intermediate layer, even if the number of service models 21 or the number of device models 23 increases, the first mapping information and the second mapping information are defined separately. Consequently, the total number of mappings can be reduced, and the SDN development burden can be alleviated.

A controller 20 of the present invention includes: a service A management unit 221c that receives a notification of instruction information with respect to a network device from a service model 21 that receives the instruction information, and transmits the instruction information to a common model management unit 222c of a common model 22 according to first mapping information between the service model 21 and the common model 22;

the common model management unit 222c that receives the notification of the instruction information from the service A management unit 221c, and transmits the instruction information to a device C management unit 223c of a device model 23 according to second mapping information between the common model 22 and the device model 23; and

the device C management unit 223c that receives the notification of the instruction information from the common model management unit 222c, and notifies a network device of the received instruction information.

With this arrangement, through the introduction of an architecture newly provided with the common model 22 as an intermediate layer, even if the number of service models 21 or the number of device models 23 increases, the total number of mappings can be reduced, and therefore the operating costs of actions such as adding and updating plugins with respect to the controller 20 can be reduced.

### REFERENCE SIGNS LIST

10 plugin generation device

11 mapping loading unit

12 config loading unit

13 plugin generation unit

14 plugin output unit

20 controller

21 service model

22 common model

23 device model

221c service A management unit (service management unit)

222c common model management unit

223c device C management unit (device management unit)

1. A plugin generation device comprising:
a mapping loading unit, including one or more processors, configured to load, into a controller configured to transmit instruction information with respect to a network device from a service model that receives the instruction information to a device model that notifies the network device of the received instruction information, first mapping information between the service model and a common model and second mapping information between the common model and the device model as information for mapping the service model and the device model, respectively;
a config loading unit, including one or more processors, configured to load preconditions for generating a plugin as config information;
a plugin generation unit, including one or more processors, configured to generate a plugin to be incorporated into the controller on a basis of the first mapping information, the second mapping information, and the config information; and
a plugin output unit, including one or more processors, configured to output the generated plugin to the controller, and thereby cause the controller to execute a process of transmitting the instruction information according to the first mapping information and the second mapping information.

2. The plugin generation device according to claim 1, wherein the controller comprises:
a service management unit, including one or more processors, configured to receive a notification of instruction information with respect to a network device from a service model that receives the instruction information, and transmits the instruction information to a common model management unit of a common model according to first mapping information between the service model and the common model;
the common model management unit, including one or more processors, configured to receive the notification of the instruction information from the service management unit, and transmit the instruction information to a device management unit of a device model according to second mapping information between the common model and the device model; and
the device management unit, including one or more processors configured to receive the notification of the instruction information from the common model management unit, and notify a network device of the received instruction information.

3. A plugin generation method comprising:
loading, into a controller that transmits instruction information with respect to a network device from a service model that receives the instruction information to a device model that notifies the network device of the received instruction information, first mapping information between the service model and a common model and second mapping information between the common model and the device model as information for mapping the service model and the device model, respectively;
loading preconditions for generating a plugin as config information;
generating a plugin to be incorporated into the controller on a basis of the first mapping information, the second mapping information, and the config information; and
outputting the generated plugin to the controller, and thereby causing the controller to execute a process of transmitting the instruction information according to the first mapping information and the second mapping information.

4. A non-transitory computer readable medium storing one or more instructions causing a computer to execute a process comprising:
loading, into a controller that transmits instruction information with respect to a network device from a service model that receives the instruction information to a device model that notifies the network device of the received instruction information, first mapping information between the service model and a common model and second mapping information between the common model and the device model as information for mapping the service model and the device model, respectively;
loading preconditions for generating a plugin as config information;
generating a plugin to be incorporated into the controller on a basis of the first mapping information, the second mapping information, and the config information; and
outputting the generated plugin to the controller, and thereby causing the controller to execute a process of transmitting the instruction information according to the first mapping information and the second mapping information.
